(19) United States
(12) Patent Application Publication
(10) Pub. No.: US 2018/0274599 A1
(43) Pub. Date: Sep. 27, 2018

(54) TORQUE TRANSMISSION ASSEMBLY TO BE PROVIDED IN A MOTOR VEHICLE TRANSMISSION

(71) Applicant: VALEO EMBRAYAGES, Amiens Cedex 2 (FR)

(72) Inventors: Rabah ARHAB, Amiens (FR); Herve RIBOT, Amiens (FR); Laurent CAUMARTIN, Amiens (FR); Francois THIBAUT, Amiens (FR); David DELPLACE, Amiens (FR)

(73) Assignee: VALEO EMBRAYAGES, Amiens Cedex 2 (FR)

(21) Appl. No.: 15/762,736

(22) PCT Filed: Sep. 22, 2016
(86) PCT No.: PCT/FR2016/052400

§ 371 Date: Mar. 23, 2018

(30) Foreign Application Priority Data
Sep. 24, 2015 (FR) 1559026

(51) Int. Cl. F16D 21/06

(52) U.S. Cl. CPC F16D 21/06; F16D 2300/26

(57) ABSTRACT

A torque transmission assembly provided in a motor vehicle transmission. The torque transmission assembly comprises at least a clutch housing and a torque transmission module including: a cover, a wet dual-clutch mechanism rotatable about an axis, and a clutch casing comprising, in whole or in part, an oil dispensing device for supplying oil to the wet dual clutch. The cover and the clutch casing are assembled so as to form a housing defining a cavity in which the wet dual-clutch mechanism is received at least in part, and wherein the clutch casing is received, in whole or in part, in the clutch housing, and the cover comprises a first bearing surface capable of resting on an internal combustion engine.

The present invention relates to a torque-transmission assembly designed to equip a motor-vehicle transmission.

Such a torque-transmission assembly is designed to constitute part of a transmission, especially for a motor vehicle or for a so-called industrial vehicle, wherein this latter may be, for example, a heavy truck, a vehicle for public transportation or an agricultural vehicle.

The present invention relates more particularly to a torque-transmission assembly having in particular a wet double clutch, which can move rotationally around an axis of rotation and which is controlled so as to selectively couple a driving shaft of an internal combustion engine to a first driven shaft and to a second driven shaft of a gearbox.

Transmissions having a wet double-clutch mechanism (or “double wet clutch” in English), generally of multiple-disk type, are known from the prior art, wherein the said mechanism is installed in the clutch housing of the motor vehicle.

The interest expressed in this type of transmission is growing by reason of its performances achieved in terms of comfort, gain in fuel consumption and reduction of CO₂ emissions.

The object of the present invention is to improve the motor-vehicle transmission having a wet double-clutch mechanism by proposing:

A torque-transmission assembly designed to equip a motor-vehicle transmission, having at least:
a clutch housing,
a torque-transmission module comprising:
   a cover plate
   a wet double-clutch mechanism, which can move rotationally around an axis, and
   a clutch casing containing all or part of an oil-distribution device designed to supply the wet double clutch with oil,

wherein the cover plate and the clutch casing are assembled in such a way as to form a box defining a seat in which the wet double-clutch mechanism is received at least partly,

the torque-transmission assembly is such that the clutch casing is received completely or partly in the clutch housing and the cover plate has a first bracing surface capable of being braced, especially directly, on an internal combustion engine crankcase.

According to the invention, this torque-transmission assembly has the advantage that it frees up radial space within its torque-transmission module, wherein this freed-up radial space may then be allocated to the wet double-clutch mechanism.

The first bracing surface of the cover plate is capable in particular of becoming braced on the internal combustion engine crankcase when the torque-transmission module is assembled.

The radial dimensioning of the wet double-clutch mechanism may be enlarged, which has the advantage of improving the torque-transmission capacity and the general performances of the wet double-clutch mechanism.

According to the invention, this torque-transmission assembly has the advantage that it groups the functional surfaces for assembling the torque-transmission module and the clutch housing with the engine crankcase on one and the same bracing surfaces of the torque-transmission assembly. Stated otherwise, this first bracing surface combines the functions of axial positioning of the torque-transmission module and of the clutch housing.

Preferably, the cover plate, generally disk-shaped around the axis of rotation, has on its outer periphery a fixation portion that defines the first bracing surface.

According to the invention, this torque-transmission assembly has the advantage that it groups the fixation surfaces of the torque-transmission assembly and of the torque-transmission module on the motor-vehicle transmission by virtue of one and the same fixation portion. Stated otherwise, the fixation portion combines the functions of axial positioning and of transmission of forces between the internal combustion engine crankcase and the clutch housing.

The invention may have one or other of the characteristics described hereinafter combined with one another or independently of one another.

Preferably, the cover plate, the wet double-clutch mechanism and the clutch casing are preassembled to form a one-piece assembly.

According to the exemplary embodiment of the invention, the cover plate has a second bracing surface that becomes braced on the clutch housing.

The first bracing surface is defined in a plane perpendicular to the axis of rotation.

Advantageously, the first bracing surface and the second bracing surface belong respectively to opposite sides of the fixation portion.

Preferably, the first and second bracing surfaces radially overlap one another at least partly.

Advantageously, the first and second bracing surfaces are situated radially over the same diameter.

According to the exemplary embodiment of the invention, the cover plate has a first centering surface capable of centering the torque-transmission assembly relative to the internal combustion engine crankcase.

The first centering surface is orthogonal to the first bracing surface of the cover plate.

The axis of revolution of the first centering surface coincides with the axis of rotation.

The cover plate may have a second centering surface capable of centering the clutch casing relative to the cover plate.

Preferably, the second centering surface of the cover plate is cylindrical and the cover plate has an annular throat that discharges into the second centering surface.

The axis of revolution of the second centering surface coincides with the axis of rotation.

Preferably, a seal is disposed between the cover plate and the clutch casing, wherein the said seal is inserted into the annular throat in such a way that it is compressed during assembly of the cover plate with the clutch casing.

The seal may be of the O-ring type.

The seal is made in particular of Nitrile™, Viton™ or rubber material.

According to the exemplary embodiment of the invention, the fixation portion of the cover plate may comprise a third bracing surface situated radially over a diameter smaller than the first bracing surface, wherein the said bracing surface is capable of receiving the clutch casing.

The third bracing surface belongs on the side of the fixation portion opposite that to which the first bracing surface belongs.

Advantageously, the clutch casing, generally bell-shaped around the axis of rotation, has on its outer periphery a fixation collar capable of being braced directly on the third bracing surface.

The cover plate may have a second bracing surface that becomes braced on the clutch housing.

Preferably, the fixation collar of the clutch casing comprises a third centering surface capable of centering the torque-transmission module relative to the clutch housing.

Advantageously, the third centering surface of the clutch casing is cylindrical and the clutch casing has an annular throat that discharges into the third centering surface.

Preferably, a seal is disposed between the clutch casing and the clutch housing, wherein the said seal is inserted into the annular throat in such a way that it is compressed during assembly of the torque-transmission module with the clutch housing.

The seal may be of the O-ring type.

The seal is made in particular of Nitrile™, Viton™ or rubber material.

According to the exemplary embodiment of the invention, the cover plate and the clutch casing are joined to one another by way of tightening of a series of first fixation screws.

Preferably, the series of first fixation screws is distributed circumferentially around the axis of rotation on the periphery of the cover plate and of the clutch casing.

The series of first fixation screws may pass through orifices made on the fixation portion of the cover plate and become screwed into drilled-tapped holes made in the fixation collar of the clutch casing.

Advantageously, the fixation collar of the clutch casing has a series of tapped holes capable of receiving the series of first fixation screws.

The cover plate and the clutch housing may be joined to one another by way of tightening of a series of second fixation screws.

Preferably, the series of second fixation screws is distributed circumferentially around the axis of rotation on the periphery of the cover plate and of the clutch housing.

Advantageously, the series of second fixation screws may pass through orifices made on the fixation portion of the cover plate and become screwed into drilled-tapped holes made in the periphery of the clutch housing.

The series of first fixation screws and the series of second fixation screws may be situated on different installation diameters.

Another object of the invention is to propose a motor-vehicle transmission for selectively joining at least one driven shaft of the gearbox to rotate with a driving shaft of the internal combustion engine, wherein the said transmission has at least:
an engine flywheel joined to rotate with the driving shaft,
a mechanism for filtration of acyclical irregularities,
a gearbox,
   and the torque-transmission assembly such as defined hereinabove.

Stated otherwise, the motor-vehicle transmission for selectively joining at least one driven shaft of the gearbox to rotate with a driving shaft of the internal combustion engine may have at least:
an engine flywheel joined to rotate with the driving shaft,
a mechanism for filtration of acyclical irregularities,
a clutch housing,
a torque-transmission module comprising:
   a cover plate
   a wet double-clutch mechanism, which can move rotationally around an axis, and
   a clutch casing containing all or part of an oil-distribution device designed to supply the wet double clutch with oil,

in which the cover plate and the clutch casing are assembled in such a way as to form a box defining a seat in which the wet double-clutch mechanism is received at least partly,

and in which the cover plate has on its outer periphery a fixation portion, which is capable of becoming braced on an internal combustion engine crankcase and is disposed axially between the said crankcase of the internal combustion engine and the clutch housing.

Advantageously, the cover plate and the clutch housing may be provided to be fixed on the internal combustion engine crankcase by way of tightening of a series of third fixation screws.

Preferably, the series of third fixation screws is distributed circumferentially around the axis of rotation on the periphery of the internal combustion engine crankcase.

The second fixation screws and the third fixation screws may be distributed circumferentially in alternating manner around the axis of rotation.

Advantageously, the series of third fixation screws passes through orifices made on the fixation portion of the cover plate and is capable of being screwed into drilled-tapped holes made in the periphery of the internal combustion engine crankcase.

According to another aspect, another object of the invention is to propose a torque-transmission assembly designed to equip a motor-vehicle transmission, having at least:
a clutch housing,
a torque-transmission module comprising:
   a cover plate
   a clutch casing containing all or part of an oil-distribution device designed to supply the wet double clutch with oil,
   a wet double-clutch mechanism having, around an axis of rotation, at least one first clutch and one second clutch respectively of multiple-disk type, wherein the first clutch has at least one first piston and the second clutch has at least one second piston, wherein the said first and second pistons are displaced axially in opposite directions so as to come into engaged position, where they squeeze a multiple-disk assembly against reaction means,

wherein the connection between the cover plate and the clutch casing is established in a plane that is perpendicular to the axis of rotation and is axially offset relative to the first and second clutches.

The connection between the cover plate and the clutch casing is in particular outside the axial installation of the multiple-disk assemblies of the first and second clutches.

The connection between the cover plate and the clutch casing is in particular offset in the direction of the internal combustion engine crankcase.

The transmission assembly according to this other aspect may comprise all or part of the characteristics mentioned in the foregoing.

The invention will be better understood by reading the description hereinafter, given solely by way of example and written with reference to the attached drawings, wherein:

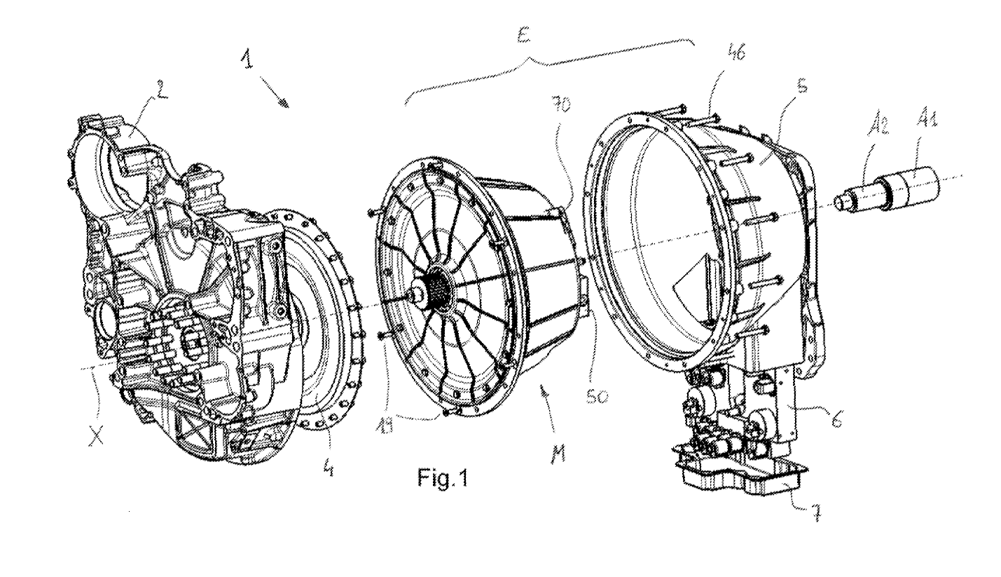

FIG. 1 is a view in perspective of a kinematic transmission train having a torque-transmission assembly according to one preferred embodiment of the invention;

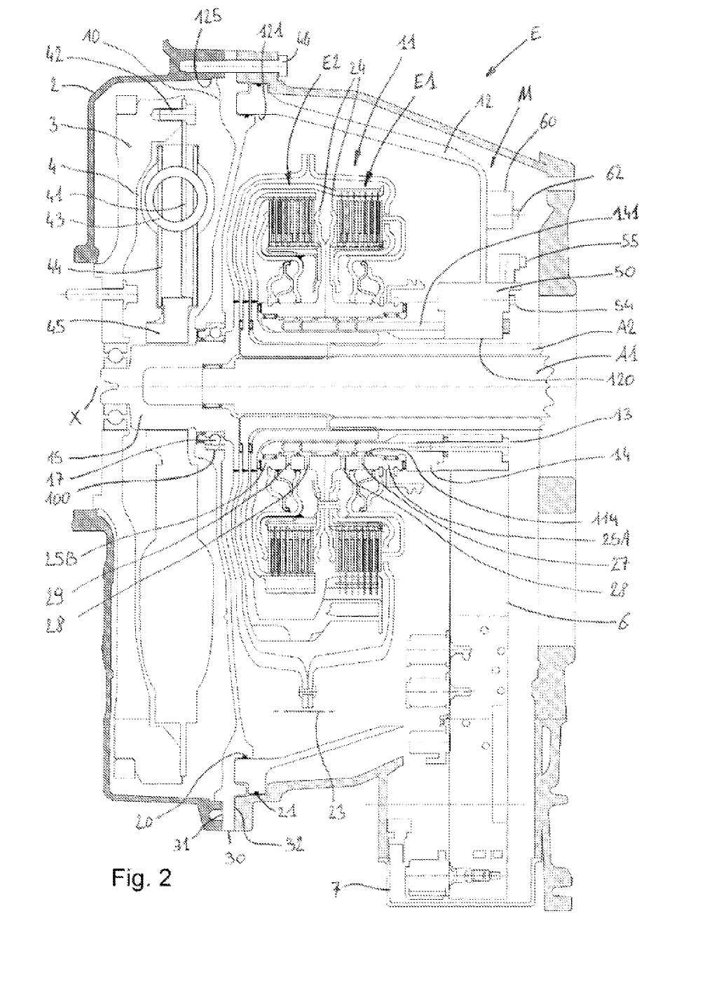

FIG. 2 is a view in section of the kinematic transmission train and of the torque-transmission assembly passing through axis of rotation X of FIG. 1;

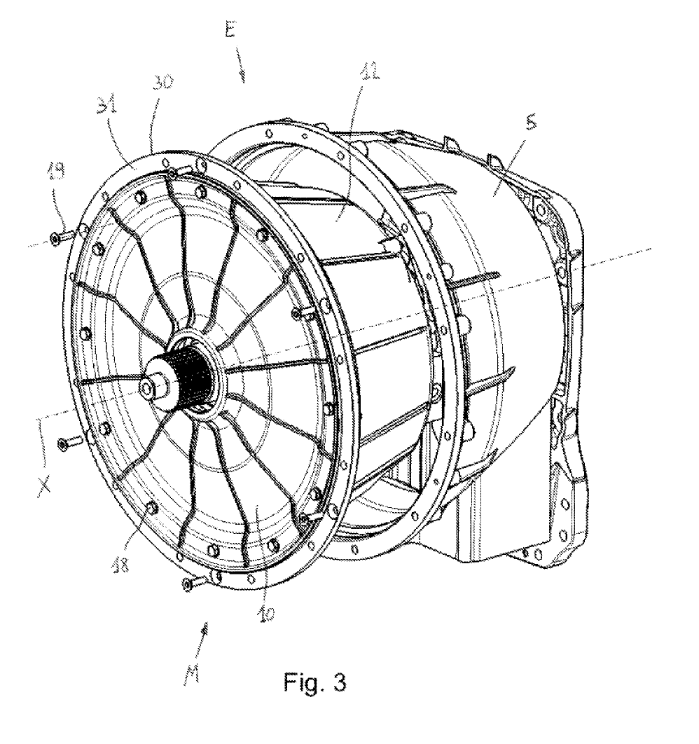

FIG. 3 is a view in perspective of the torque-transmission assembly of FIG. 1;

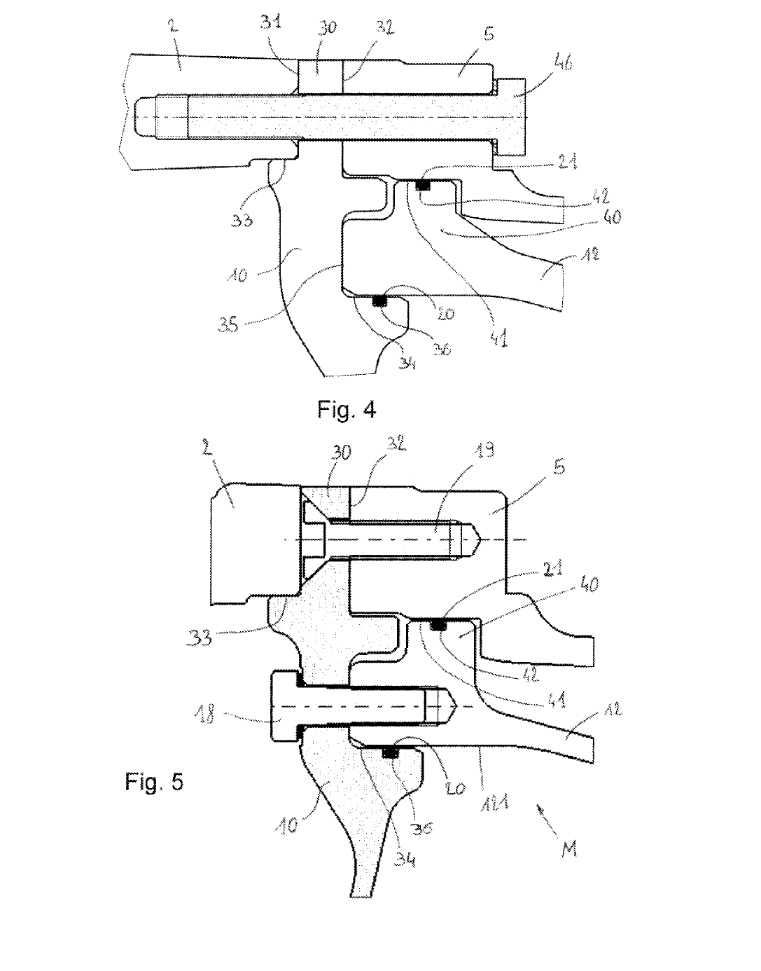

FIG. 4 is a partial and enlarged view in section of the torque-transmission assembly of FIG. 2;

FIG. 5 is another view in section according to V-V of the torque-transmission assembly of FIG. 2.

In order to facilitate understanding thereof, the terms “front” or “rear” will be used non-limitatively in the description hereinafter and in the claims to denote the direction relative to an axial orientation determined by the primary axis X of rotation of the transmission of the motor vehicle, as will the terms “inside/internal” and “outside/external”, relative to axis X, to denote a radial orientation, orthogonal to the said axial orientation.

FIG. 1 represents a motor-vehicle transmission 1 comprising:
an engine flywheel 3,
a mechanism 4, cooperating with engine flywheel 3, for filtration of acyclical irregularities,
a torque-transmission assembly E,
two driven shafts A1, A2 of a gearbox (not shown) associated with torque-transmission assembly E.

Transmission 1 of the motor vehicle is assembled with an internal combustion engine crankcase 2.

Torque-transmission assembly E comprises in particular:
a clutch housing 5, and
a torque-transmission module M comprising:
   a cover plate 10,
   a wet double-clutch mechanism 11, which can move rotationally around axis X, and
   a clutch casing 12 containing all or part of an oil-distribution device 50 designed to supply the wet double clutch with oil.

Wet double-clutch mechanism 11 has at least one first clutch E1 and one second clutch E2, which are respectively of multiple-disk type.

Torque-transmission module M, clutch housing 5 and oil pan 7 are assembled in such a way as to form a container in which a servo 6 is received. Servo 6 is fixed on torque-transmission module M. The function of servo 6 is to control the supply of oil to wet double-clutch mechanism 11 by way of oil distribution device 50.

As illustrated in FIG. 2, oil distribution device 50 has a hub support 14 fixed on clutch casing 12. Hub support 14 and clutch casing 12 are joined to one another by way of tightening of fixation screws 13. Hub support 14 supports wet double-clutch mechanism 11 in rotation by way of needle bearings.

Oil pan 7 is fixed on clutch housing 5 by way of tightening of fixation screws (not shown). A seal (not shown) is disposed between oil pan 7 and clutch housing 5 and compressed by tightening of the fixation screws in such a way that it establishes leak-tightness to a fluid, for example oil, present in clutch housing 5 and at the bottom of oil pan 7.

FIG. 2 represents certain components of a motor-vehicle transmission 1 and the components of torque-transmission module M.

Engine flywheel 3 fixed on the crankshaft of the internal combustion engine (not shown) is contained in internal combustion engine crankcase 2. Transmission of engine torque from the engine flywheel to the gearbox takes place by a mechanism 4 for filtering out acyclical irregularities. Mechanism 4 for filtering out acyclical irregularities comprises a primary shroud 41 joined to rotate with engine flywheel 3 by way of fixation screw 42. Primary shroud 41 is connected by helical springs 43 to a secondary means 44 constituted by two guide washers integral with a splined hub 45. Splined hub 45 is joined to rotate with a splined torque input shaft 15 of torque-transmission module M.

As illustrated in FIGS. 1 and 2, cover plate 10 has the general shape of a disk around axis of rotation X and clutch casing 12 has the general shape of a bell. Cover plate 10 and clutch casing 12 are manufactured by using casting processes. Cover plate 10 and clutch casing 12 are assembled in such a way as to form a box defining a seat in which wet double-clutch mechanism 11 is received at least partly.

According to the exemplary embodiment of the invention presented in FIG. 2, clutch casing 12 is received entirely in clutch housing 5. Clutch casing 12 has a first opening 120, which is situated at the apex of the bell shape and is arranged for the passage of shafts A1 and A2 of the gearbox of the motor-vehicle transmission.

Clutch casing 12 has a second opening 121 bounded over its rim by a fixation collar 40 and situated on the base of the clutch casing. Fixation collar 40, which has annular shape, has a massive section designed to impart rigidity to clutch casing 12. First and second openings 120, 121 of clutch casing 12 are circular and concentric around axis X. Fixation collar 40 becomes braced on cover plate 10.

Alternatively, clutch casing 12 may be received partly in clutch housing 5.

Cover plate 10 has on its outer periphery a fixation portion 30 of circular shape. Fixation portion 30 defines a first bracing surface 31, which comes braced directly on internal combustion engine crankcase 2. First bracing surface 31 is perpendicular to axis X. Fixation portion 30 is in contact with clutch casing 12. More precisely, fixation collar 40 of clutch casing 12 becomes braced directly on fixation portion 30 of cover plate 10.

Cover plate 10 also has a central opening 100 made for passage of a splined torque-input shaft 15 of wet double-clutch mechanism 11. Splined shaft 15 extends axially toward the outside of module M and passes through cover plate 10 via the said central opening 100. Cover plate 10 is stiffened by means of ribs extending radially from central opening 100 to fixation portion 30.

Splined torque-input shaft 15 is guided in rotation on cover plate 10 by way of a ball bearing 17. Central opening 100 of cover plate 10 comprises a cylindrical portion, on which ball bearing 17 is shrink-fitted. Ball bearing 17 also ensures leak-tightness to oil on the rear part of torque-transmission module M.

Wet double-clutch mechanism 11 has an external envelope 23 of general shape generated by revolution. This external envelope 23 defines the rotating volume of wet double-clutch mechanism 11.

Clutch casing 12 is assembled with cover plate 10 in a plane that is perpendicular to axis of rotation X and is offset axially relative to wet double-clutch mechanism 11. In the described example, the assembly plane is offset axially toward the rear of transmission module M in such a way that the connection between cover plate 10 and clutch casing 12 is offset axially relative to first and second clutches E1 and E2. The assembly plane is outside the axial installation of the multiple-disk assemblies.

The axial offset of the assembly plane has the advantage that it frees up radial space within its torque-transmission module, wherein this freed-up radial space may then be allocated to the wet double-clutch mechanism.

The radial dimensioning of the wet double-clutch mechanism defined by external envelope 23 may be enlarged, which has the advantage of improving the torque-transmission capacity.

Wet double-clutch mechanism 11 is controlled so as to selectively couple the said driving shaft to a first driven shaft A1 and to a second driven shaft A2 of the gearbox.

Preferably, first driven shaft A1 and second driven shaft A2 are coaxial.

First driven shaft A1 is driven in rotation when the said first clutch E1 is closed and second driven shaft A2 is driven in rotation when the said second clutch E2 is closed, wherein the said first and second driven shafts A1, A2 are respectively connected to a gearbox equipping the motor vehicle.

In wet double-clutch mechanism 11, first clutch E1 acts, for example, both for startup and engagement of the odd ratios and second clutch E2 then controls the even ratios and reverse gear; alternatively, the ratios controlled by the said first and second clutches E1 and E2 are inverted.

For example, first clutch E1 is disposed axially in front on the gearbox side and, for example, second clutch E2 is disposed axially to the rear on the engine side.

First clutch E1 and second clutch E2 transmit the input power (the torque and the speed) alternatively from the driving shaft, which receives input shell 22 of mechanism 11, to one of the two driven shafts A1, A2, as a function of the open or closed state of each of clutches E1 and E2.

Preferably, first clutch E1 and second clutch E2 are in open state, also known as “normally open”, and are activated selectively by a servo 6 to switch from the open state to the closed state.

First clutch E1 has at least one first piston and second clutch E2 has at least one second piston, wherein the said first and second pistons are displaced axially in opposite directions such that, in engaged position, they squeeze a multiple-disk assembly against reaction means 24. Reaction means 24 are joined to rotate with input shell 22 by a riveted joint.

Wet double-clutch mechanism 11 is controlled hydraulically by way of a pressurized fluid, generally oil.

In order to control the change of state of first clutch E1 and of second clutch E2 of mechanism 11 of torque-transmission module M selectively, oil-distribution device 50 uses hub support 14 having oil-supply ducts 141, of which there are four, for example, as shown in FIG. 2.

Hub support 14 also comprises four annular throats 114, which are machined on the external periphery of the said hub support and into which oil-supply ducts 141 respectively discharge independently.

In complementary manner, wet double-clutch mechanism 11 has at least one hub 25A, 25B having radial drilled holes, which are each connected to one of the oil-supply ducts 141.

Preferably, the said at least one hub is made in two parts, a first hub 25A and a second hub 25B, respectively associated with first clutch E1 and second clutch E2. Reaction means 24 are joined to rotate with hubs 25A and 25B.

First hub 25A has two radial drilled holes 26 and 27, which are associated with the control of first clutch E1 situated axially in front, and second hub 25B also has two radial drilled holes 28 and 29, which are associated with the control of second clutch E2 situated axially to the rear.

First and second hubs 25A and 25B pivot around hub support 14, which is aligned with axis of rotation X.

Thus the four annular throats 114 of support hub 14 are disposed axially facing drilled holes 26, 27, 28 and 29 of hubs 25A and 25B, in such a way as to supply the hydraulic-piston chambers of clutches E1 and E2 separately. A seal is disposed between each throat in such a way as to ensure leak-tightness between the different supply ducts. The seal is generally of O-ring type.

FIGS. 1 and 2 show clutch casing 12 containing an oil-distribution device 50 designed to supply the wet double clutch with oil. Oil-distribution device 50 itself has an oil-directing box 51 supported completely or partly by clutch casing 12 and hub support 14. In the described example, oil-directing box 51 is integrated with clutch casing 12. Oil-supply ducts 141 of hub support 14 are connected to outlet lines of directing box 51.

As illustrated in FIG. 2, oil-directing box 51 partly surrounds first opening 120 of the clutch casing. Oil-directing box 51 has oil-supply ducts (not shown) also designed to pass the oil from the outside of torque-transmission module M to wet double-clutch mechanism 11.

Oil-distribution device 50 as shown in FIGS. 1 to 3 comprises two pumps 60, 70 supported by clutch casing 12. Clutch casing 12 is provided with bracing zones, generally machined from solid stock, serving as face for fixation to the casings of pumps 60, 70. The pumps are fixed mechanically on clutch casing 12 by means of fixation screws.

Pump 70 here is of the low-pressure type, and their main function is to remove oil from the bottom of oil pan 7 and deliver it to a cooling circuit situated outside clutch housing 5.

The functioning of the low-pressure oil circuit will be understood more easily by reading the following paragraph:

The oil is aspirated from the bottom of oil pan 7 by the low-pressure pump via a tube (not shown) dipping into the oil tank. The tube is joined to a hydraulic inlet connector of the low-pressure pump. Low-pressure pump 70 delivers the oil toward a heat exchanger by way of an outlet connector (not shown). The oil cooled under the action of the heat exchanger returns to oil-directing box 51 by way of an inlet connector 54. The cooled oil circulates in oil-directing box 51 before being sent directly into servo 6.

Pump 60 here is of the high-pressure type 60, and its main function is to remove oil from the bottom of oil pan 7 and deliver it to an oil filter situated outside clutch housing 5.

The functioning of the high-pressure oil circuit will be understood more easily by reading the following paragraph:

The oil is aspirated from the bottom of oil pan 7 by the high-pressure pump via a tube (not shown) dipping into the oil tank. The tube is joined to a hydraulic inlet connector of the high-pressure pump. High-pressure pump 60 first delivers the oil toward an oil filter by way of an outlet connector 62. The oil filtered by virtue of its passage through the oil filter returns to oil-directing box 51 by way of an inlet connector 55. The filtered oil circulates in oil-distribution box 51 before being sent directly into servo 6.

The main function of servo 6 is to control the oil supply to the hydraulic piston chambers of clutches E1 and E2. To do so, servo 6 sends pressurized oil into oil-supply ducts 141 of hub support 14 by way of oil-directing box 51.

FIG. 3 shows a perspective view of the connection of clutch housing 5 with torque-transmission module M.

Cover plate 10 and clutch casing 12 are joined to one another by way of tightening of a series of first fixation screws 18. The series of first fixation screws 18 passes through orifices made on fixation portion 30 of cover plate 10 and become screwed into drilled-tapped holes made in fixation collar 40 of clutch casing 12. The heads of first fixation screws 18 are braced on fixation portion 30.

The series of first fixation screws 18 is distributed circumferentially around axis X on the periphery of cover plate 10 and of clutch casing 12. In this way, cover plate 10, wet double-clutch mechanism 11 and clutch housing 12 are preassembled to form a one-piece assembly. Advantageously, preassembly may take place directly on the assembly line of the clutch supplier.

Cover plate 10 and clutch housing 5 are joined to one another by way of tightening of a series of second fixation screws 19. The series of second fixation screws 19 passes through orifices made on fixation portion 30 of cover plate 10 and become screwed into drilled-tapped holes made in the periphery of clutch housing 5. The heads of second fixation screws 19 are seated in recesses made on first bracing surface 31. In this way, the axial space requirement of fixation portion 30 is reduced.

The series of second fixation screws 19 is distributed circumferentially around axis X on the periphery of cover plate 10 and of clutch housing 5.

The series of first fixation screws 18 and the series of second fixation screws 19 are situated on different installation diameters. The series of first fixation screws 18 is situated on an installation diameter smaller than that of the series of second fixation screws 19.

FIG. 4 shows a detailed view of the connection of torque-transmission assembly E with internal combustion engine crankcase 2.

Cover plate 10 has, on fixation portion 30, a second bracing surface 32 that becomes braced on clutch housing 5. First bracing surface 31 and second bracing surface 32 belong respectively to opposite sides of fixation portion 30. Fixation portion 30 of the cover plate is disposed axially between the said internal combustion engine crankcase 2 and clutch housing 5. In the described example, first and second bracing surfaces 31 and 32 overlap radially. Bracing surfaces 31 and 32 are machined to guarantee the geometric assembly tolerances.

Cover plate 10 has a first centering surface 33 capable of centering torque-transmission assembly E relative to internal combustion engine crankcase 2. This first centering surface 33 is machined and becomes seated in an interior bore 125 of internal combustion engine crankcase 2.

First centering surface 33 is also orthogonal to first bracing surface 31 of cover plate 10.

Cover plate 10 and clutch housing 5 are fixed on internal combustion engine crankcase 2 by way of tightening of a series of third fixation screws 46. The series of third fixation screws 46 is distributed circumferentially around axis X on the periphery of internal combustion engine crankcase 2. In the described example, the series of third fixation screws 46 passes through orifices made on fixation portion 30 of cover plate 10 and becomes screwed into drilled-tapped holes made in the periphery of internal combustion engine crankcase 2.

Second fixation screws 19 and third fixation screws 46 are distributed circumferentially in alternating manner around axis X.

FIG. 5 presents a detailed view of the connection of transmission module M relative to clutch housing 5.

Cover plate 10 has a second cylindrical centering surface 34 capable of centering clutch casing 12 relative to the said cover plate 10. The axis of revolution of second centering surface 34 coincides with axis X. This second centering surface 34 is machined and becomes seated in second opening 121 of clutch casing 12.

The function of torque-transmission module M is in particular to contain the volume of oil necessary for functioning of wet double-clutch mechanism 11. A seal 20 is disposed radially between cover plate 10 and clutch casing 12. Cover plate 10 has an annular throat 36 that discharges into second centering surface 34. In particular, seal 20 is inserted into annular throat 36 in such a way that it is compressed during assembly of cover plate 10 with clutch casing 12.

Seal 20 is of the O-ring type. The material of the seal may be Nitrile™, Viton™ or rubber.

As illustrated in FIGS. 4 and 5, fixation portion 30 of cover plate 10 comprises a third bracing surface 35, which is situated radially over a diameter smaller than first bracing surface 31. This third bracing surface 31 is capable of receiving clutch casing 12. Third bracing surface 35 belongs on the side of fixation portion 30 opposite that to which first bracing surface 31 belongs.

Fixation collar 40 becomes braced directly on third bracing surface 35 of cover plate 10.

Fixation collar 40 of clutch casing 12 comprises a third centering surface 41 capable of centering torque-transmission module M relative to clutch housing 5. Third centering surface 41 of clutch casing 12 is cylindrical.

The function of torque-transmission assembly M is in particular to contain the volume of oil necessary for functioning of the torque-transmission module.

A seal 21 is disposed between clutch casing 12 and clutch housing 5. Clutch casing 12 has an annular throat 42 that discharges into the third centering surface 41. In particular, seal 21 is inserted into annular throat 42 in such a way that it is compressed during assembly of torque-transmission module M with clutch housing 5.

Seal 21 is of the O-ring type. The material of the seal may be Nitrile™, Viton™ or rubber.

The use of the invention described in the foregoing is not limited to wet double-clutch mechanisms in which the first and second clutches are installed axially side-by-side. The invention described is also applicable to wet double-clutch mechanisms in which the first and second clutches are installed axially on the same plane and consequently are superposed radially. According to this other architecture, the torque-transmission assembly exhibits the same advantages in terms of ease of mounting on the motor-vehicle transmission.

1. A torque-transmission assembly designed to equip a motor-vehicle transmission, comprising:
a clutch housing; and,
a torque-transmission module including a cover plate, a wet double-clutch mechanism, which can move rotationally around an axis, and a clutch casing containing all or part of an oil-distribution device designed to supply the wet double clutch with oil,
wherein the cover plate and the clutch casing are assembled in such a way as to form a box defining a seat in which the wet double-clutch mechanism is received at least partly, and
wherein the clutch casing is received completely or partly in the clutch housing and the cover plate has a first bracing surface capable of being braced on an internal combustion engine crankcase.

2. The torque-transmission assembly according to claim 1, wherein the cover plate generally disk-shaped around the axis, has on its outer periphery a fixation portion that defines the first bracing surface.

3. The torque-transmission assembly according to claim 1, wherein the cover plate has a second bracing surface that becomes braced on the clutch housing.

4. The torque-transmission assembly according to claim 3, wherein the first bracing surface and the second bracing surface belong respectively to opposite sides of the fixation portion.

5. The torque-transmission assembly according to claim 1, wherein the cover plate has a first centering surface capable of centering the torque-transmission assembly relative to the internal combustion engine crankcase.

6. The torque-transmission assembly according to claim 1, wherein the cover plate has a second centering surface capable of centering the clutch casing relative to the cover plate.

7. The torque-transmission assembly according to claim 6, wherein the second centering surface of the cover plate is cylindrical and the cover plate has an annular throat that discharges into the second centering surface, and in that a seal is disposed between the cover plate and the clutch casing, wherein the said seal is inserted into the annular throat in such a way that it is compressed during assembly of the cover plate with the clutch casing.

8. The torque-transmission assembly according to claim 2, wherein the fixation portion of the cover plate comprises a third bracing surface situated radially over a diameter smaller than the first bracing surface, wherein the said third bracing surface is capable of receiving the clutch casing.

9. The torque-transmission assembly according to claim 8, wherein the clutch casing, generally bell-shaped around the axis, has on its outer periphery a fixation collar capable of being braced directly on the third bracing surface of the cover plate.

10. The torque-transmission assembly according to claim 9, wherein the fixation collar of the clutch casing comprises a third centering surface capable of centering the torque-transmission module relative to the clutch housing.

11. The torque-transmission assembly according to claim 10, wherein the third centering surface of the clutch casing is cylindrical and the clutch casing has an annular throat that discharges into the third centering surface, and in that a seal is disposed between the clutch casing and the clutch housing, wherein the said seal is inserted into the annular throat in such a way that it is compressed during assembly of the torque-transmission module with the clutch housing.

12. The torque-transmission assembly according to claim 2, wherein the cover plate and the clutch casing are connected to one another by way of tightening of a series of first fixation screws, wherein the said series of first fixation screws passes through orifices made on the fixation portion of the cover plate and become screwed into drilled-tapped holes made in the fixation collar of the clutch casing.

13. The torque-transmission assembly according to claim 2, wherein the cover plate and the clutch housing are connected to one another by way of tightening of a series of second fixation screws, wherein the said series of second fixation screws passes through orifices made on the fixation portion of the cover plate and become screwed into drilled-tapped holes made in the periphery of the clutch housing.

14. A motor-vehicle transmission for selectively joining at least one driven shaft of the gearbox to rotate with a driving shaft of the internal combustion engine, wherein the transmission has at least:
an engine flywheel joined to rotate with the driving shaft,
a mechanism for filtration of acyclical irregularities,
a gearbox,
which transmission has the torque-transmission assembly according to claim 1.

15. The motor-vehicle transmission according to claim 14, wherein the cover plate and the clutch housing are provided to be fixed on the internal combustion engine crankcase by way of tightening of a series of third fixation screws, wherein the said series of third fixation screws passes through orifices made on the fixation portion of the cover plate and are capable of becoming screwed into drilled-tapped holes made in the periphery of the internal combustion engine crankcase.
